(19) United States
(12) Patent Application Publication
(10) Pub. No.: US 2017/0080857 A1
(43) Pub. Date: Mar. 23, 2017

(54) Tactical Threat Assessor for a Vehicle

(71) Applicant: Ford Global Technologies, LLC, Dearborn, MI (US)

(72) Inventors: David A. HERMAN, Southfield, MI (US); Nicholas COLELLA, Grosse Ile, MI (US); Charles Michael BROADWATER, Orchard Lake, MI (US); Vilay PATEL, Canton, MI (US)

(21) Appl. No.: 14/857,309

(22) Filed: Sep. 17, 2015

(51) Int. Cl. B60Q 9/00; G01C 21/36; G01S 13/04; G06K 9/00; G01S 15/04; G01S 15/93; G01S 17/02; G01S 17/93; G01C 21/34; G01S 13/93

(52) U.S. Cl. CPC B60Q 9/008; G01C 21/34; G01C 21/3697; G01C 21/3667; G01S 13/04; G01S 13/931; G01S 15/04; G01S 15/931; G01S 17/026; G01S 17/936; G06K 9/00805

(57) ABSTRACT

A vehicle includes a plurality of sensors configured to detect objects in a plurality of zones adjacent the vehicle, and a controller. The controller is programmed to, in response to the vehicle approaching a path defining a next turn of a predefined navigational route and a vehicle being detected in a predefined subset of the zones selected to be on a same side of the vehicle as a direction of the turn, generate a collision alert.

### TECHNICAL FIELD

The present disclosure relates to a system and method for identifying potential collision threats of the vehicle prior to issuing navigational guidance to the driver and for warning the driver of potential collision threats based on at least route data and vehicle-sensor data.

### BACKGROUND

Many modern vehicles include an in-vehicle navigation system able to receive an active route and provide turn-by-turn directions to a driver. The system may provide auditory prompts through the vehicle speakers or may provide visual prompts on a display. Current navigation systems provide prompts based on the position of the vehicle relative to the next maneuver (e.g. turn right in 500 feet).

### SUMMARY

According to one embodiment, a vehicle includes a plurality of sensors configured to detect objects in a plurality of zones adjacent the vehicle, and a controller. The controller is programmed to, in response to the vehicle approaching a path defining a next turn of a predefined navigational route and a vehicle being detected in a predefined subset of the zones selected to be on a same side of the vehicle as a direction of the turn, generate a collision alert.

According to another embodiment, a method of identifying potential collision threats for a vehicle is presented. The vehicle has sensors configured to detect objects in a plurality of zones adjacent the vehicle. The method includes, in response to the vehicle approaching a path defining a next turn of a predefined navigational route and a vehicle being detected in a predefined subset of the zones selected to be on a same side of the vehicle as a direction of the turn, generating a collision alert.

According to yet another embodiment, a vehicle includes at least one sensor configured to detect objects in a zone adjacent the vehicle and send sensor data, and a controller. The controller is programmed to receive the sensor data and to receive a navigational route. The controller is further programmed to, in response to the vehicle being at a first distance from a next turn of the navigational route, (i) check a predefined subset of the zones for another vehicle that is selected to be on a same side of the vehicle as a direction of the turn, and (ii) generate a collision alert if another vehicle is within the predefined subset.

In some embodiments, the controller is further programmed to pin a first guidance flag on the navigational route at a second distance from the next turn that is closer to the next turn than the first distance, and delay issuing the directions prompt until the vehicle reaches the second distance if another vehicle is not within the predefined subset.

### BRIEF DESCRIPTION OF THE DRAWINGS

FIG. 1 is a system diagram for an example vehicle-based computing system.

FIG. 2 is a schematic diagram of a vision system for an example vehicle.

FIG. 3 is diagrammatical plan view of an example driving scenario.

FIGS. 4A and 4B are flow charts illustrating control logic for the vehicle-based computing system.

FIG. 5 is a screen shot of a display of a vehicle according to one embodiment.

FIG. 6 is a screen shot of a display of a vehicle according to another embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

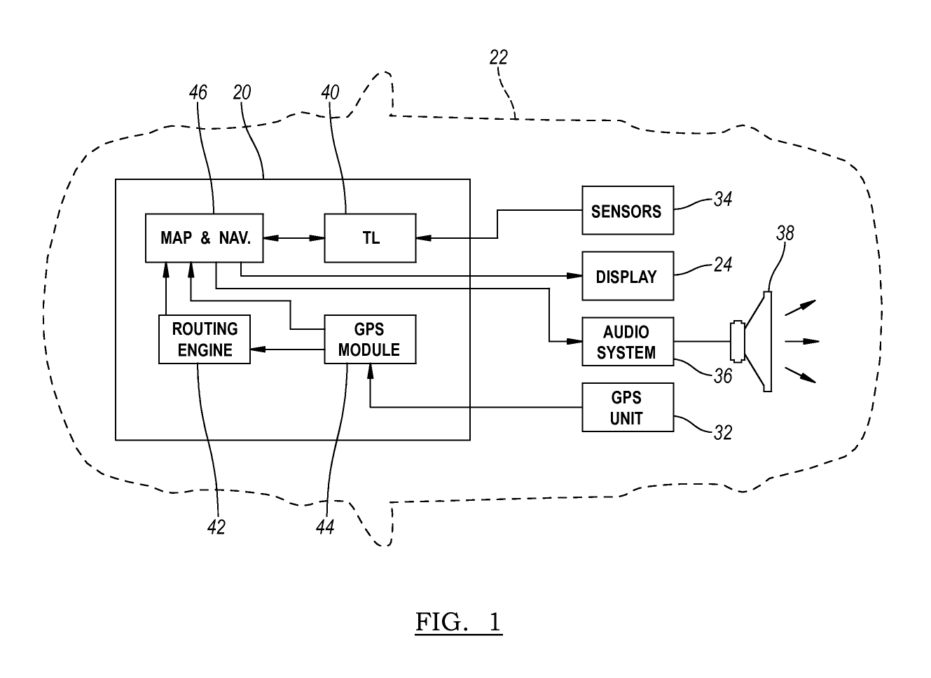

FIG. 1 illustrates an example block topology for a vehicle 22 having a vehicle-based computing system (VCS) 20. An example of such a vehicle-based computing system 20 is the SYNC system manufactured by THE FORD MOTOR COMPANY. The SYNC system is described in U.S. Pat. No. 8,738,574, the content of which are hereby incorporated by reference in their entirety. A vehicle enabled with a vehicle-based computing system may contain a visual front end interface (display) 24 located in the vehicle. The user may also be able to interact with the interface if it is provided, for example, with a touch sensitive screen. In another illustrative embodiment, the interaction occurs through button presses or a spoken dialog system with automatic speech recognition and speech synthesis.

The VCS 20 includes one or more controllers for controlling the function of various components. The controllers may communicate via a serial bus (e.g., Controller Area Network (CAN)) or via dedicated electrical conduits. The controller generally includes any number of microprocessors, ASICs, ICs, memory (e.g., FLASH, ROM, RAM, EPROM and/or EEPROM) and software code to co-act with one another to perform a series of operations. The controller also includes predetermined data, or “lookup tables” that are based on calculations and test data, and are stored within the memory. The controller may communicate with other vehicle systems and controllers over one or more wired or wireless vehicle connections using common bus protocols (e.g., CAN and LIN). Used herein, any reference to “a controller” refers to one or more controllers.

The VCS 20 includes a processor that controls at least some portion of the operation of the VCS. Provided within the vehicle, the processor allows onboard processing of commands and routines. Further, the processor is connected to both non-persistent and persistent storage. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid-state drives, portable USB drives and any other suitable form of persistent memory.

The processor is also provided with a number of different inputs allowing the user to interface with the processor—for example, via the display 24, a microphone, an auxiliary input, or a USB input. The processor also includes a number of vehicle inputs including, but not limited to, a GPS unit 32, and a plurality of sensors 34. The sensors may include speed sensors, vision units, and yaw sensors, among others. Although not shown, numerous vehicle components and auxiliary components in communication with the VCS 20 may use a vehicle network (such as, but not limited to, a CAN bus) to pass data to and from the VCS (or components thereof).

Outputs to the system include, but are not limited to, the visual display 24 and an audio system 36 having a speaker 38. The speaker 38 is connected to an amplifier and receives its signal from the processor through a digital-to-analog converter.

The VCS 20 includes hardware, software, and firmware for executing the various functionalities of the vehicle 22. The VCS 20 may include threat logic 40, a routing engine 42, a GPS module 44, and a map and navigation module 46. These modules are configured to send and receive signals between one another in order to accomplish select functionalities of the vehicle 22.

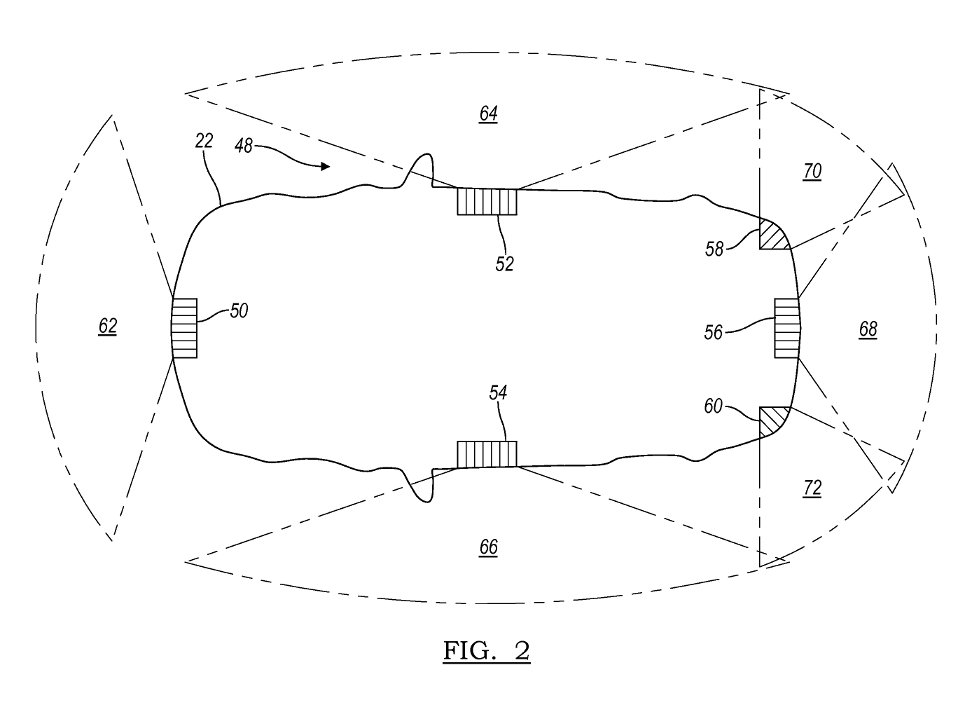

Referring to FIG. 2, the vehicle 22 includes a vision system 48 having a plurality of sensors that inspect an area surrounding the vehicle 22. The vision system 48 may employ radar, LIDAR, cameras, ultrasound, or sonar, and any combination thereof. In the illustrated embodiment, the vision system 48 includes a front unit 50, a passenger-side unit 52, a diver-side unit 54, a rear unit 56, and first and second rear quarter-panel units 58 and 60. Each of the units inspects a portion of the area surrounding the vehicle 22. A unit's inspecting area may be referred to as a zone. For example, the front unit 50 has an inspection zone 62, the passenger-side unit 52 has an inspection zone 64, the driver-side unit 54 has an inspection zone 66, the rear unit 56 has an inspection zone 68, the quarter-panel unit 58 has an inspection zone 70, and the quarter-panel unit 60 has an inspection zone 72. One or more of the zones may overlap to ensure sufficient coverage of the area surrounding the vehicle and to prevent blind spots. Each of the units detect objects within their respective zone. For example, the units can detect other vehicles, debris, pedestrians, fixed objects (e.g. light pole) or other collision hazards. The vision system 48 may be able to differentiate between different types of objects, and may be able to determine attributes of the detected object, such as size, speed, and heading. The units of the vision system 48 enable the vehicle to provide warnings and semi-autonomous functionality. For example, the vehicle 22 may include one or more of: adaptive cruise control, blind-spot detection, surround view, cross-traffic alerts, emergency braking, rear-park assist, and collision warnings.

The vision system 48 outputs signals that are received by the threat logic 40 of the processor. The threat logic 40 includes software having algorithms for calculating a threat matrix indicating the probability of a collision. Using the threat matrix, the VSC 20 may issue driver alerts and/or autonomously operate the vehicle (e.g. apply the brakes).

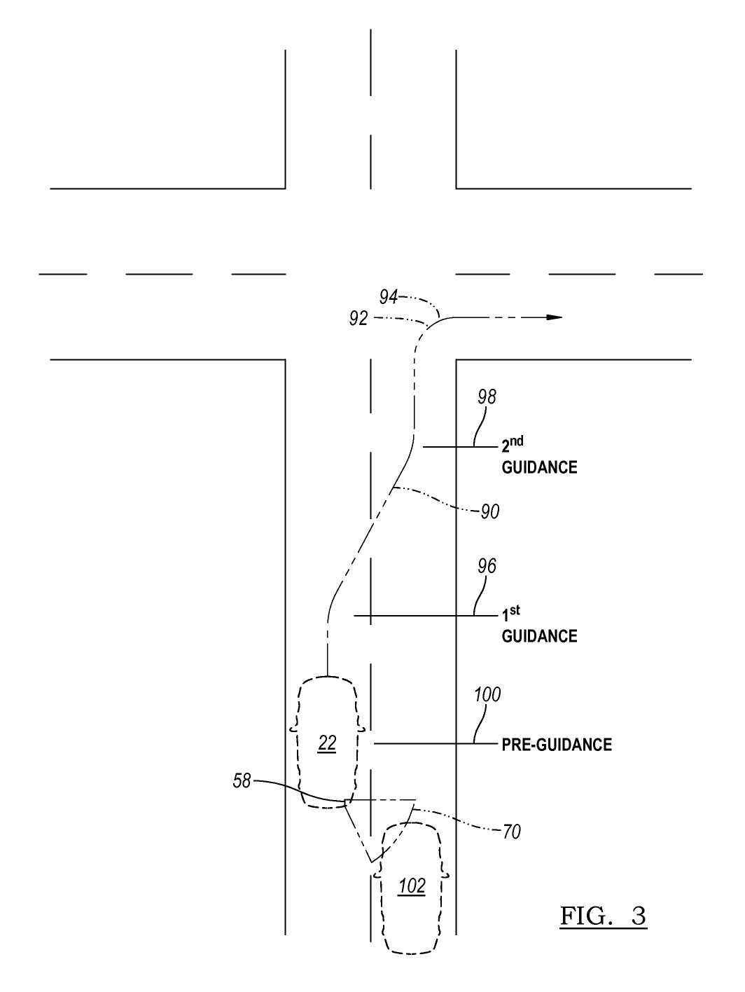

FIG. 3 illustrates a portion of an example navigational route 90 for the vehicle 22. The navigational route 90 may be input by a passenger of the vehicle 22 via the display 24, by voice command, or by other means. The navigational route 90 is generated based on a current position of the vehicle (determined by the GPS unit 32, or by user input data) and a desired final destination. The navigational route includes a path 92 that defines at least one turn 94. For example, FIG. 3 illustrates a portion of the path 92 defining a right turn 94.

The VCS 20 is programmed to provide prompts (auditory and/or visual) to the driver at one or more guidance points to instruct the driver on the next maneuver. An example prompt is an audio or visual message telling the diver to turn right in 500 feet. The guidance points are located at respective distances upstream of the next maneuver (i.e. right-hand turn 94). The distances may be predetermined and stored. For example, FIG. 3 illustrates a first guidance 96 and a second guidance 98. Other embodiments may include more than two guidance points, such as three, four, or five. The number and location of the guidances may be dependent upon the speed of the vehicle. The guidances may be located at a predetermined travel time from the next maneuver. For example, the first guidance 96 may be located at a distance that is 30 seconds prior to the right-hand turn 94, and the second guidance 98 may be located at a distance that is five seconds prior to the right-hand turn 94. Alternatively, the guidances may be located at a predetermined distance from the next maneuver. For example, the first guidance may be located 1000 feet prior to the right-hand turn 94, and the second guidance 98 may be located 100 feet prior to the right-hand turn 94.

Conventional navigation systems issue direction prompts without regard to whether it is actually safe to execute the maneuver. For example, a conventional navigation system would issue a prompt (e.g. turn right) at a guidance point without consulting whether or not a vehicle is located in an adjacent right lane. It is advantageous to provide a collision warning to drivers in connection with the direction prompts to reduce collision risks. The VCS 20 of the vehicle 22 is programmed such that the threat logic 40, the routing engine 42, the GPS module 44, and the map and navigational module 46 cooperate to determine the predicted safety of executing the next maneuver and provide driver instructions accordingly.

The VCS 20 is programmed to issue an early prompt at a pre-guidance location 100 if a collision threat is detected. Whether or not an object is a collision threat is based on a direction of the path. For example, if the next maneuver is a right turn, the system checks a subset of zones located on the right half of the vehicle, as objects left of the vehicle do not pose a collision threat for the upcoming right-hand turn 94. The subset of zones may be predefined. For example, for a right-hand turn, the controller checks a first predefined subset of zones, and for a left-hand turn, the controller checks a second predefined subset of zones. The pre-guidance location 100 may be set at a distance corresponding to an estimated travel time to the first guidance point 96. For example, the pre-guidance location may be 3 to 15 seconds upstream of the first guidance point 96.

In the illustrated embodiment, the vehicle 22 is traveling in a left-hand lane of the road, and is approaching a right-hand turn. In order to execute the right-hand turn, the vehicle 22 will first have to merge into the right lane of the road and then execute a right-hand turn at the intersection. The vision system 48 of vehicle 22 detects another vehicle 102 within one of more of the zones, such as zone 70. The vision system 48 periodically sends information to the threat logic 40 that interprets the information into a guidance threat matrix. The threat matrix may include status information for each of the zones. The status information may include “object present” or “clear.” The map and navigational module 46 may ignore the guidance threat matrix until the vehicle 22 reaches the pre-guidance location 100. When the vehicle reaches the pre-guidance 100, the map and navigational module 46 polls the status for a relevant subset of zones from the guidance threat matrix. Using this information, the navigational module 46 determines if a threat exists in the path of an upcoming maneuver. In the illustrated example, at pre-guidance point 100, the map and navigation module 46 polls the status for the first predefined subset of zones (e.g. zones on the right half of the vehicle). If any of the zones in the first predefined subset has an “object present” status, the VCS 20 sends instructions to issue a collision warning to the driver and/or a directions prompt. In the illustrated example, the vehicle 102 is located in a relevant zone and thus a collision warning and/or a directions prompt is issued at pre-guidance 100. If the vehicle 102 were not present, no action would be taken at pre-guidance 100 and the vehicle would delay a directions prompt until the vehicle reached the first guidance 96. The navigation module 46 will continue to poll the threat logic 40 for statuses of the zones at predefined points, such as at the guidances 96 and 98. If the vehicle 102 continues to be collision hazard, or if a new object is detected, the VCS 20 will issue a collision warning with the directions prompt at the guidance 96 and 98.

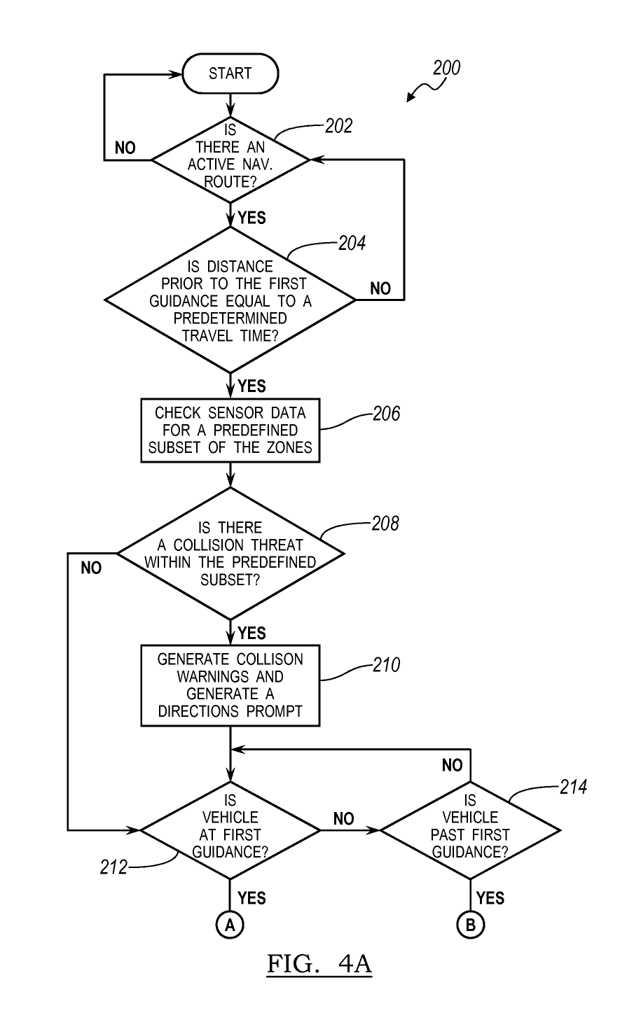

FIG. 4 illustrates an example control logic 200 executed by the VSC 20 to operate some functionality of the navigation system. The control logic begins by determining if there is an active navigational route at operation 202. If there is an active route, control passes to operation 204. At operation 204 the controller determines if the vehicle is at a pre-guidance location by determining if the distance prior to the first guidance is equal to a predetermined travel time. If the vehicle is not at the pre-guidance location, control loops back to operation 202. If the vehicle is at the pre-guidance location, the controller checks the sensor data for a predefined subset of the inspection zones at operation 206. The predefined subset is selected based on a direction of the path. At operation 208 the controller determines if there is a collision threat within the predefined subset of the zones. If yes, a collision warning and/or a directions prompt is provided to the driver at the pre-guidance location. If a collision threat is not present, control passes to operation 212. At operation 212 the controller determines if the vehicle 22 is at the first guidance point. If no, the controller determines if the vehicle is past the first guidance at operation 214. If the vehicle is not past the first guidance, control loops back to operation 212. Once the vehicle 22 reaches the first guidance a directions prompt is issued to the driver at operation 216. At operation 218 the controller determines if a collision threat is present within the predefined subset of zones. If no, control passes operation 222. If there is a collision threat, a collision warning is issued to the driver in conjunction with the directions prompt at operation 220. At operation 222 the controller determines if the vehicle is at the second guidance point. If no, the controller determines if the vehicle is past the second guidance point at operation 224. If the vehicle is past the second guidance point control loops back to the start. If vehicle is at the second guidance point, a directions prompt is issued to the driver at operation 226. At operation 228 the controller determines if there is a collision threat in the predefined subset. If yes, a collision warning is issued at operation 230. If no, control loops back to the start.

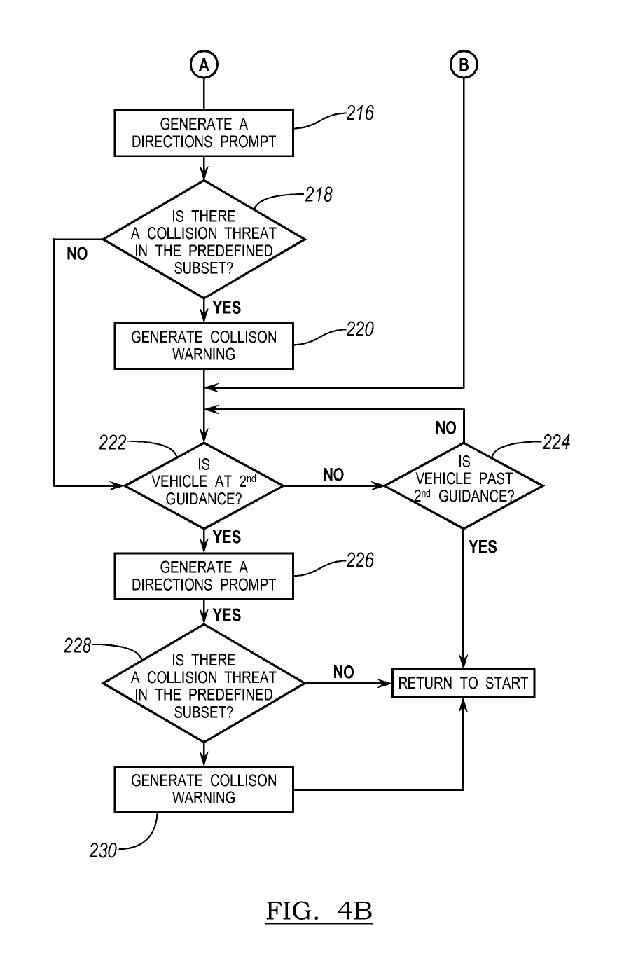

Referring to FIG. 5, a screenshot of the navigation page 250 on the display 24 is shown. The navigation page 250 illustrates a navigational route 252 which is overlaid on top of map data. The vehicle's current location is illustrated by an arrow 254 that points in the vehicle's current direction of travel. The vehicle is currently at a first guidance point and the display is showing a directions prompt 256. The controller has detected a collision threat and a collision warning 258 is also displayed. In this example, the collision warning is a circle (such as a red circle) around the arrow 254. In some embodiments, the circle may blink. However, it is to be appreciated that collision warning may be any type of indicator that alerts the driver to potential danger. For example, the warning may include text stating “COLLISION THREAT” or similar language. The audio system 36 may issue an auditory warning in conjunction with the visual warning on the display.

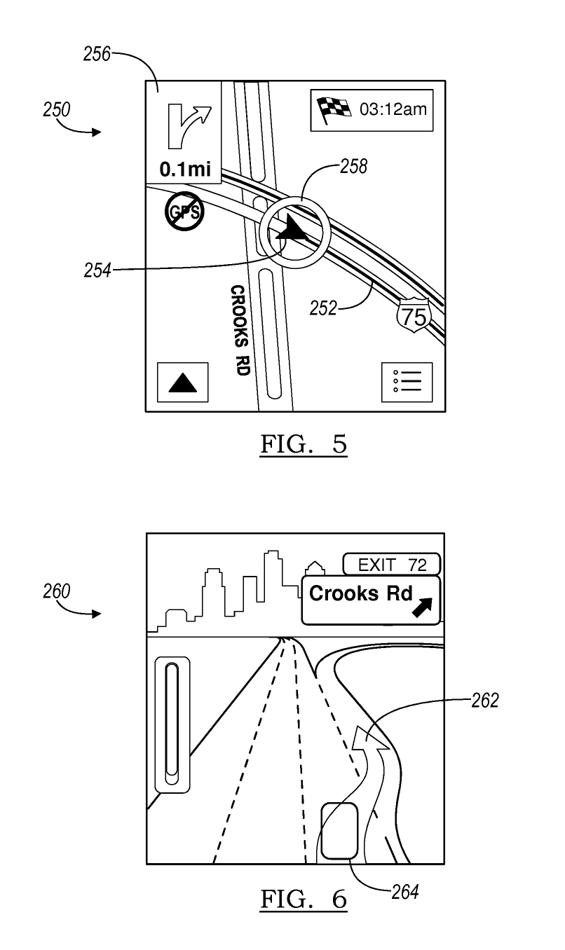

FIG. 6 illustrates a screenshot of another navigational page 260 on the display 24. In this embodiment, the directions prompt is illustrated by an arrow 262 overlaid on a schematic of the road. The collision warning 264 is a red (or other color) overlay on top of the arrow 262.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
sensors configured to detect objects in a plurality of zones adjacent the vehicle; and
a controller programmed to, in response to the vehicle approaching a path defining a next turn of a predefined navigational route and a vehicle being detected in a predefined subset of the zones selected to be on a same side of the vehicle as a direction of the turn, generate a collision alert.

2. The vehicle of claim 1 wherein the controller generates the alert further in response to the vehicle being at a threshold distance from the next turn.

3. The vehicle of claim 2 wherein the threshold distance is defined by a predetermined travel time of the vehicle to the next turn.

4. The vehicle of claim 1 wherein the controller is further programmed to, in response to the vehicle approaching a path defining a next turn of a predefined navigational route and a vehicle being detected in a predefined subset of the zones, generate a directions command.

5. The vehicle of claim 1 wherein the collision alert is auditory.

6. The vehicle of claim 1 further comprising a display, wherein the collision alert is a visual alert on the display.

7. A method of identifying potential collision threats for a vehicle having sensors configured to detect objects in a plurality of zones adjacent the vehicle comprising:
in response to the vehicle approaching a path defining a next turn of a predefined navigational route and a vehicle being detected in a predefined subset of the zones selected to be on a same side of the vehicle as a direction of the turn, generating a collision alert.

8. The method of claim 7 further comprising, in response to the vehicle approaching a path defining a next turn of a predefined navigational route and a vehicle being detected in a predefined subset of the zones, generating a directions prompt to a driver of the vehicle.

9. The method of claim 7 wherein the alert is generated further in response to the vehicle being at a threshold distance from the next turn.

10. The method of claim 7 wherein the alert is auditory.

11. The method of claim 7 further comprising receiving the navigational route.

12. A vehicle comprising:
at least one sensor configured to detect objects in a zone adjacent the vehicle and send sensor data; and
a controller programmed to
receive the sensor data,
receive a navigational route, and
in response to the vehicle being at a first distance from a next turn of the navigational route, (i) check a predefined subset of the zones for another vehicle that is selected to be on a same side of the vehicle as a direction of the turn, and (ii) generate a collision alert if another vehicle is within the predefined subset.

13. The vehicle of claim 12 wherein the first distance is defined by a predetermined travel time of the vehicle to the next turn.

14. The vehicle of claim 12 wherein the first distance is based on a speed of the vehicle.

15. The vehicle of claim 12 further comprising a display configured to show a map of the navigational route, wherein the collision alert is a visual warning on the map shown on the display.

16. The vehicle of claim 12 wherein the controller is further programmed to, in response to the vehicle being at the first distance from the next turn, generate a directions prompt if another vehicle is within the predefined subset.

17. The vehicle of claim 16 wherein the controller is further programmed to
pin a first guidance flag on the navigational route at a second distance from the next turn that is closer to the next turn than the first distance, and
delay issuing the directions prompt until the vehicle reaches the second distance if another vehicle is not within the predefined subset.

18. The vehicle of claim 12 wherein the collision alert is an auditory prompt.
